(19) United States
(12) Patent Application Publication
(10) Pub. No.: US 2016/0021877 A1
(43) Pub. Date: Jan. 28, 2016

(54) EMULSIFIABLE CONCENTRATE COMPRISING PESTICIDE, ALKYL BENZOATE AND FATTY ACID AMIDE

(71) Applicant: BASF SE, Ludwigshafen (DE)

(72) Inventors: Murat MERTOGLU, Ludwigshafen (DE); Stefan BECHTEL, Schwegenheim (DE); Natascha ANNAWALD, Schifferstadt (DE)

(21) Appl. No.: 14/773,600

(22) PCT Filed: Feb. 28, 2014
(86) PCT No.: PCT/EP2014/053907

§ 371 Date: Sep. 8, 2015

Related U.S. Application Data
(60) Provisional application No. 61/778,636, filed on Mar. 13, 2013.

(30) Foreign Application Priority Data
Mar. 13, 2013 (EP) 13159002.8

(51) Int. Cl. A01N 25/30; A01N 43/56; A01N 43/653; A01N 25/04

(52) U.S. Cl. CPC A01N 25/30; A01N 25/04; A01N 43/56; A01N 43/653

(57) ABSTRACT

Subject matter of the present invention is an emulsifiable concentrate comprising a water-insoluble pesticide, an alkyl benzoate, and an amide of the formula (I) as defined herein. The invention further relates to a process for the preparation of said concentrate; an emulsion obtainable by mixing water, a water-insoluble pesticide, the alkyl benzoate, and the amide; and to a method for controlling phytopathogenic fungi and/or undesired vegetation and/or undesired attack by insects or mites and/or for regulating the growth of plants, where the concentrate or the emulsion is allowed to act on the respective pests, their environment or on the crop plants to be protected from the respective pests, on the soil and/or on undesired plants and/or on the crop plants and/or their environment.

Subject matter of the present invention is an emulsifiable concentrate comprising a water-insoluble pesticide, an alkyl benzoate, and an amide of the formula (I) as defined herein. The invention further relates to a process for the preparation of said concentrate; an emulsion obtainable by mixing water, a water-insoluble pesticide, the alkyl benzoate, and the amide; and to a method for controlling phytopathogenic fungi and/or undesired vegetation and/or undesired attack by insects or mites and/or for regulating the growth of plants, where the concentrate or the emulsion is allowed to act on the respective pests, their environment or on the crop plants to be protected from the respective pests, on the soil and/or on undesired plants and/or on the crop plants and/or their environment. The present invention comprises combinations of preferred features with other preferred features.

Emulsifiable concentrates (also referred to as EC) are widely used formulations in crop protection. The disadvantage of the known emulsifiable concentrates is the poor cold stability, the pronounced tendency to crystallize and the low pesticide concentration.

It was an object of the present invention to provide an emulsifiable concentrate which overcomes these disadvantages.

The object was achieved by an emulsifiable concentrate comprising a water-insoluble pesticide, an alkyl benzoate, and an amide of the formula (I)

R¹—C(O)N(R²)₂ (I)

where R¹ is C₅-C₁₉-alkyl and R² is C₁-C₄-alkyl.

Usually, an emulsifiable concentrate is taken to mean compositions which form an oil-in-water emulsion upon mixing with water (e.g. in a weight ratio of 1 part concentrate to 99 parts water). The emulsion usually arises spontaneously. The resulting emulsion may have an average droplet size of more than 0.1 μm, preferably more than 0.5 μm, in particular more than 0.8 μm, and most preferred more than 1.1 μm. The average droplet size may be determined by laser diffraction, e.g. with a Malvern Mastersizer 2000.

The concentrate is preferably present as a homogeneous solution. It is usually virtually free from dispersed particles.

Suitable alkyl benzoates are alkyl benzoates where the phenyl group is optionally substituted with at least one alkyl group. Preferably, the alkyl benzoate is a linear or branched C₁₋₁₂ alkyl benzoate, more preferably a linear or branched C₁₋₆ alkyl benzoate, and in particular a linear or branched Cm alkyl benzoate.

Optionally, the phenyl group is substituted with at least one (e.g. one or two, wherein one is preferred) alkyl group, which may be linear or branched. The alkyl groups may be identical or different, where they are preferably identical. The alkyl group is preferably a linear or branched C₁₋₃ alkyl group, and in particular a methyl group. Examples for alkyl benzoates where the phenyl group is substituted with at least one alkyl group are: methyl o-toluate (CAS 89-71-4), methyl p-toluate (CAS 99-75-2), ethyl toluate, propyl toluate, butyl toluate, methyl dimethylbenzoate, ethyl dimethylbenzoate, propyl dimethylbenzoate, butyl dimethylbenzoate, methyl ethylbenzoate, ethyl ethylbenzoate, propyl ethylbenzoate, and butyl ethylbenzoate. The term toluate may be 2-methylbenzoate, 3-methylbenzoate, or 4-methylbenzoate. The term dimethylbenzoate may be 3,4-dimethylbenzoate, 3,5-dimethylbenzoate, 2,6-dimethylbenzoate, or 2,3-dimethylbenzoate. The term ethylbenzoate may be 2-ethylbenzoate, 3-ethylbenzoate, or 4-ethylbenzoate.

Preferred are alkyl benzoates where the phenyl group is not substituted. Examples are methyl benzoate, ethyl benzoate, n-propyl benzoate, iso-propyl benzoate, n-butyl benzoate, iso-butyl benzoate, pentyl benzoate, hexyl benzoate, heptyl benzoate and octyl benzoate. Most preferred alkyl benzoate is butyl benzoate, in particular n-butyl benzoate.

The concentrate can comprise at least 2% by weight, preferably at least 5% by weight, more preferably at least 8% by weight, and in particular at least 10% by weight of alkyl benzoate (such as butyl benzoate). The concentrate can comprise not more than 80% by weight, preferably not more than 50% by weight and in particular not more than 25% by weight of the alkyl benzoate.

Preferred amides of the formula (I) are those in which R¹ is C₇-C₁₁-alkyl (preferably linear) and R² is methyl. Especially preferred amides of the formula (I) are those in which R¹ is C₇-C₁₁-alkyl and R² is methyl. In particular, R¹ is nonyl and/or undecyl and R² is methyl.

Mixtures of amides of the formula (I) are also possible, for example mixtures where R¹ is C₇-C₁₁-alkyl and R² is methyl. Mixtures of amides of the formula (I) comprise in most cases two amides of the formula (I) in an amount of in each case at least 30% by weight (preferably at least 40% by weight) based on the total amount of amides of the formula (I).

The weight ratio of the alkyl benzoate to the amide of the formula (I) may be in the range from 1:20 to 10:1, preferably from 1:10 to 4:1, more preferably from 1:6 to 1.5:1, and in particular from 1:4 to 1:1.2.

The concentrate can comprise not more than 80% by weight, preferably not more than 65% by weight and in particular not more than 55% by weight of amide of the formula (I). The concentrate can comprise at least 5% by weight, preferably at least 9% by weight and in particular at least 13% by weight of amide of the formula (I).

The concentrate may further comprise further solvents (e.g. the organic solvents listed below) in addition to the alkyl benzoate and the amide of the formula (I). The concentrate can comprise not more than 30% by weight, preferably not more than 12% by weight and in particular not more than 7% by weight of further solvents. In another form, the concentrate may comprises not more than 5% by weight, preferably not more than 1% by weight and in particular not more than 0.3% by weight of aliphatic, cyclic and aromatic hydrocarbons (for example toluene, paraffin, tetrahydronaphthalene, alkylated naphthalenes).

The amounts of the alkyl benzoate and the amide of the formula (I) may add up to a sum of 5 to 95% by weight, preferably 40 to 90% by weight, and in particular 55 to 85% by weight.

The concentrate can comprise from 1 to 70% by weight of the alkyl benzoate (e.g. butyl benzoate), and 1 to 80% by weight of the amide of the formula (I) (e.g. in which R¹ is C₇-C₁₁-alkyl and R² is methyl), wherein the amounts of these components adds up to a sum of 40 to 95% by weight.

Preferably, the concentrate can comprise from 5 to 50% by weight of the alkyl benzoate (e.g. butyl benzoate), and 5 to 65% by weight of the amide of the formula (I) (e.g. in which R¹ is C₇-C₁₁-alkyl and R² is methyl), wherein the amounts of these components adds up to a sum of 40 to 95% by weight.

In particular, the concentrate can comprise from 10 to 30% by weight of the alkyl benzoate (e.g. butyl benzoate), and 10 to 55% by weight of the amide of the formula (I) (e.g. in which R¹ is C₇-C₁₁-alkyl and R² is methyl), wherein the amounts of these components adds up to a sum of 40 to 95% by weight.

In most cases, the concentrate is free from water. In another form, the concentrate is essentially free from water. It can comprise not more than 3% by weight, preferably not more than 1% by weight and in particular not more than 0.5% by weight of water. In special form, the concentrate may comprise not more than 0.3% by weight and in particular not more than 0.1% by weight of water.

The term pesticides refers to at least one active substance selected from the group of the fungicides, insecticides, nematicides, herbicides, safeners and/or growth regulators. Preferred pesticides are fungicides, insecticides, herbicides and growth regulators. Especially preferred pesticides are fungicides. Mixtures of pesticides from two or more of the abovementioned classes may also be used. The skilled worker is familiar with such pesticides, which can be found, for example, in Pesticide Manual, 15th Ed. (2009), The British Crop Protection Council, London. The following pesticides are suitable, by way of example (pesticides A) to K) are fungicides):

A) Respiration inhibitors
complex-III-inhibitors at the Qₒ-site (for example strobilurins): azoxystrobin, coumethoxystrobin, coumoxystrobin, dimoxystrobin, enestroburin, fenaminstrobin, fenoxy-strobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, methyl 2-[2-(2,5-dimethylphenyloxymethyl)phenyl]-3-methoxyacrylate, 2-(2-(3-(2,6-dichlorophenyl)-1-methylallylideneaminooxymethyl)phenyl)-2-methoxyimino-N-methylacetamide, pyribencarb, triclopyricarb/chlorodincarb, famoxadon, fenamidon;
complex-III-inhibitors at the Qᵢ-site: cyazofamid, amisulbrom;
complex-II-inhibitors (for example carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthio-biphenyl-2-yl)-3-difluoromethyl-1-methyl-1H-pyrazole-4-carboxamide, N-(2-(1,3,3-trimethylbutyl)phenyl)-1,3-dimethyl-5-fluoro-1H-pyrazole-4-carboxamide and N-[9-(dichloromethylene)-1,2,3,4-tetrahydro-1,4-methanonaphthalen-5-yl]-3-(difluoromethyl)-1-methyl-1H-pyrazole-4-carboxamide;
other respiration inhibitors (for example complex I, decouplers): diflumetorim; nitrophenyl derivatives: binapacryl, dinobuton, dinocap, fluazinam; ferimzone; organometal compounds: fentin salts such as fentin acetate, fentin chloride or fentine hydroxide; ametoctradin; and silthiofam;
   B) Sterol biosynthesis inhibitors (SBI fungicides)
C14-demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, triflumizole; pyrimidines, pyridines and piperazines: fenarimol, nuarimol, pyrifenox, triforine;
delta14-reductase inhibitors: aldimorph, dodemorph, dodemorph acetate, fenpropimorph, tridemorph, fenpropidin, piperalin, spiroxamine;
3-ketoreductase inhibitors: fenhexamid;

### C) Nucleic Acid Synthesis Inhibitors

phenylamides or acylamino acid fungicides: benalaxyl, benalaxyl-M, kiralaxyl, metalaxyl, metalaxyl-M (mefenoxam), ofurace, oxadixyl;
others: hymexazole, octhilinone, oxolinic acid, bupirimate;

### D) Cell Division and Cytoskeleton Inhibitors

tubulin inhibitors such as benzimidazoles, thiophanates: benomyl, carbendazim, fuberidazole, thiabendazole, thiophanate-methyl; triazolopyrimidines: 5-chloro-7-(4-methyl-piperidin-1-yl)-6-(2,4,6-trifluorophenyl)-[1,2,4]triazolo[1,5-a]pyrimidine;
further cell division inhibitors: diethofencarb, ethaboxam, pencycuron, fluopicolid, zoxamid, metrafenon, pyriofenon;

### E) Amino Acid Synthesis and Protein Synthesis Inhibitors

methionine synthesis inhibitors (anilinopyrimidines): cyprodinil, mepanipyrim, pyrimethanil;
protein synthesis inhibitors: blasticidin-S, kasugamycin, kasugamycin hydrochloride hydrate, mildiomycin, streptomycin, oxytetracyclin, polyoxin, validamycin A;

### F) Signal Transduction Inhibitors

MAP/histidine kinase inhibitors: fluoroimide, iprodione, procymidone, vinclozolin, fenpiclonil, fludioxonil;
G-protein inhibitors: quinoxyfen;

### G) Lipid and Membrane Synthesis Inhibitors

phospholipid biosynthesis inhibitors: edifenphos, iprobenfos, pyrazophos, isoprothiolane;
lipid peroxidation: dicloran, quintozene, tecnazene, tolclofos-methyl, biphenyl, chloroneb, etridiazole;
phospholipid biosynthesis and cell wall attachment: dimethomorph, flumorph, mandipropamid, pyrimorph, benthiavalicarb, iprovalicarb, valifenalate and 4-fluorophenyl N-(1-(1-(4-cyanophenyl)ethanesulfonyl)but-2-yl)carbamate;
compounds which affect cell membrane permeability and fatty acids: propamocarb, propamocarb hydrochloride

### H) “Multi-Site” Inhibitors

inorganic active substances: Bordeaux mixture, copper acetate, copper hydroxide, copper oxychloride, basic copper sulfate, sulfur;
thio- and dithiocarbamates: ferbam, mancozeb, maneb, metam, metiram, propineb, thiram, zineb, ziram;
organochlorine compounds (for example phthalimides, sulfamides, chloronitriles): anilazine, chlorothalonil, captafol, captan, folpet, dichlofluanid, dichlorophen, flusulfamide, hexachlorobenzene, pentachlorophenol and its salts, phthalid, tolylfluanid, N-(4-chloro-2-nitrophenyl)-N-ethyl-4-methylbenzenesulfonamide;
guanidines and others: guanidine, dodine, dodine-free base, guazatin, guazatin acetate, iminoctadin, iminoctadin triacetate, iminoctadin tris(albesilate), dithianon;

### I) Cell Wall Biosynthesis Inhibitors

glucan synthesis inhibitors: validamycin, polyoxin B; melanin synthesis inhibitors: pyroquilon, tricyclazole, carpropamid, dicyclomet, fenoxanil;

### J) Resistance Inductors

acibenzolar-S-methyl, probenazol, isotianil, tiadinil, prohexadione-calcium; phosphonates: fosetyl, fosetyl-aluminum, phosphorous acid and its salts;

### K) Unknown Mode of Action

bronopol, quinomethionate, cyflufenamid, cymoxanil, dazomet, debacarb, diclomezin, difenzoquat, difenzoquat-methyl sulfate, diphenylamine, fenpyrazamine, flumetover, flusulfamid, flutianil, methasulfocarb, nitrapyrin, nitrothal-isopropyl, oxine-copper, proquinazid, tebufloquin, tecloftalam, triazoxide, 2-butoxy-6-iodo-3-propylchromene-4-one, N-(cyclopropylmethoxyimino-(6-difluoromethoxy-2,3-difluorophenyl)methyl)-2-phenyl-acetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)phenyl)-N-ethyl-N-methylformamidine, N′-(5-difluoromethyl-2-methyl-4-(3-trimethylsilanylpropoxy)-phenyl)-N-ethyl-N-methylformamidine, N-methyl-(1,2,3,4-tetrahydronaphthalen-1-yl)-2-{1-[2-(5-methyl-3-trifluoromethylpyrazol-1-yl)acetyl]piperidin-4-yl}thiazole-4-carboxamide, N-methyl-(R)-1,2,3,4-tetrahydronaphthalen-1-yl-2-{1-[2-(5-methyl-3-trifluoromethylpyrazol-1-yl)-acetyl]piperidin-4-yl}thiazole-4-carboxamide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, 6-tert.-butyl-8-fluoro-2,3-dimethylquinolin-4-yl methoxyacetate, N-methyl-2-{1-[(5-methyl-3-trifluoromethyl-1H-pyrazol-1-yl)acetyl]piperidin-4-yl}-N-[(1R)-1,2,3,4-tetrahydronaphthalen-1-yl]-4-thiazolecarboxamide, 3-[5-(4-methylphenyl)-2,3-dimethylisoxazolidin-3-yl]-pyridine, 3-[5-(4-chlorophenyl)-2,3-dimethylisoxazolidin-3-yl]-pyridine (pyrisoxazol), N-(6-methoxypyridin-3-yl)cyclopropanecarboxamide, 5-chloro-1-(4,6-dimethoxypyrimidin-2-yl)-2-methyl-1H-benzoimidazole, 2-(4-chlorophenyl)-N-[4-(3,4-di-methoxyphenyl)isoxazol-5-yl]-2-prop-2-ynyloxyacetamide;

### M) Growth Regulators

abscisic acid, amidochlor, ancymidole, 6-benzylaminopurine, brassinolide, butralin, chlormequat (chlormequat chloride), choline chloride, cyclanilid, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidid, mepiquat (mepiquat chloride), metconazole, naphthaleneacetic acid, N-6-benzyladenine, paclobutrazole, prohexadione (prohexadione-calcium), prohydrojasmone, thidiazuron, triapenthenol, tributylphosphorotrithioate, 2,3,5-triiodobenzoic acid, trinexapac-ethyl and uniconazole;

### N) Herbicides

acetamides: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor;
amino acid analogs: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
bipyridyls: diquat, paraquat;
carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bromoxynil, dichlobenil, ioxynil;
imidazolinones: imazamethabenz, imazamox, imazapic, imazapyr, imazaquin, imazethapyr;
phenoxyacetic acids: clomeprop, 2,4-dichlorophenoxyacetic acid (2,4-D), 2,4-DB, dichlorprop, MCPA, MCPA-thioethyl, MCPB, mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl)sulfonyl)-3-(4,6-dimethoxypyrimidin-2-yl)urea;
triazines: ametryne, atrazine, cyanazine, dimethametryne, ethiozine, hexazinone, metamitron, metribuzine, prometryne, simazine, terbuthylazine, terbutryne, triaziflam;
ureas: chlortoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam;
others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethyl, chlorthal, cinmethylin, clomazone, cumyluron, cyprosulfamid, dicamba, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, tembotrione, thiencarbazone, topramezone, 4-hydroxy-3-[2-(2-methoxyethoxy-methyl)-6-trifluoromethylpyridin-3-carbonyl]bicyclo[3.2.1]oct-3-en-2-one, ethyl(3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6-amino-5-chloro-2-cyclopropylpyrimidine-4-carboxylate, 6-chloro-3-(2-cyclopropyl-6-methylphenoxy)pyridazin-4-ol, 4-amino-3-chloro-6-(4-chlorophenyl)-5-fluoropyridin-2-carboxylic acid, methyl 4-amino-3-chloro-6-(4-chloro-2-fluoro-3-methoxy-phenyl)pyridin-2-carboxylate and methyl 4-amino-3-chloro-6-(4-chloro-3-dimethylamino-2-fluorophenyl)pyridin-2-carboxylate;

### O) Insecticides

organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin,
insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazin; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;
nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl-[1,3,5]triazinane;
GABA antagonists: endosulfan, ethiprole, fipronil, vaniliprole, pyrafluprole, pyriprole, N-5-amino-1-(2,6-dichloro-4-methylphenyl)-4-sulfinamoyl-1H-pyrazole-3-thiocarboxamide;
macrocyclic lactones: abamectin, emamectin, milbemectin, lepimectin, spinosad, spinetoram;
mitochondrial electron transport chain inhibitor (METI) I acaricides: fenazaquin, pyridaben, tebufenpyrad, tolfenpyrad, flufenerim;
METI II and III substances: acequinocyl, fluacyprim, hydramethylnone;
decouplers: chlorfenapyr;
inhibitors of oxidative phosphorylation: cyhexatin, diafenthiuron, fenbutatin oxide, propargite;
insect ecdysis inhibitors: cryomazine;
‘mixed function oxidase’ inhibitors: piperonyl butoxide;
sodium channel blockers: indoxacarb, metaflumizone;
others: benclothiaz, bifenazate, cartap, flonicamid, pyridalyl, pymetrozin, sulfur, thiocyclam, flubendiamide, chlorantraniliprole, cyazypyr (HGW86); cyenopyrafen, flupyrazofos, cyflumetofen, amidoflumet, imicyafos, bistrifluron and pyrifluquinazone.

The pesticide is water-insoluble. Usually, it is soluble in water to not more than 1 g/l, preferably not more than 200 mg/l and in particular to not more than 50 mg/l at 25° C. Examples of water-insoluble pesticides are fluxapyroxad. Using simple preliminary experiments, the skilled worker can select a pesticide with a suitable water-solubility from the above pesticide list.

The pesticide can have a melting point of more than 40° C., preferably more than 70° C. and in particular more than 90° C.

The pesticide is preferably present in the concentrate in dissolved form. Using simple preliminary experiments, the skilled worker can select, from the above pesticide list, a pesticide with a suitable solubility.

In addition to the water-insoluble pesticide, the concentrate can comprise one or more further pesticides. The further pesticide is preferably water-insoluble. Usually, it is soluble in water to not more than 1 g/l, preferably not more than 200 mg/l and in particular not more than 50 mg/l at 25° C. Using simple preliminary experiments, the skilled worker can select a pesticide with a suitable water-solubility from the above pesticide list. In an especially preferred form, the concentrate does not comprise any further pesticide. In another especially preferred form, the further pesticide is epoxiconazol.

In a preferred form the concentrate comprises the water insoluble pesticide fluxapyroxad and optionally a further pesticide, which is water insoluble (e.g. epoxiconazol).

The concentrate may comprise from 0.1 to 60% by weight, preferably from 1 to 25% by weight, in particular from 5 to 15% by weight, of pesticide, the basis being the total of all the pesticides present in the concentrate.

The emulsifiable concentrate can furthermore comprise auxiliaries conventionally used for crop protection products. Suitable auxiliaries are solvents, liquid carriers, surfactants, dispersants, emulsifiers, wetters, adjuvants, solubilizers, penetrants, protective colloids, stickers, thickeners, bactericides, antifreeze agents, antifoam agents, colorants, adhesives and binders.

Suitable solvents and liquid carriers are organic solvents such as mineral oil fractions with medium to high boiling point, for example kerosene, diesel oil; oils of vegetable or animal origin; aliphatic, cyclic and aromatic hydrocarbons, for example toluene, paraffin, tetrahydro-naphthalene, alkylated naphthalenes; alcohols, for example ethanol, propanol, butanol, cyclohexanol; glycols; ketones, for example cyclohexanone; esters, for example carbonates, fatty acid esters, gamma-butyrolactone; fatty acids; phosphonates; amines; amides, for example N-methylpyrrolidone; and their mixtures.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetrant, protective colloid, or auxiliary. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates. Preferred anionic surfactants are sulfates and sulfonates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate. Preferred nonionic surfactants are alkoxylates. Nonionic surfactants such as alkoxylates may also be employed as adjuvants.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds which have negligible or even no pesticidal activity themselves, and which improve the biological performance of the compound I on the target. Examples are surfactants, mineral or vegetable oils, and other auxilaries. Further examples are listed by Knowles, Adjuvants and Additives, Agrow Reports DS256, T&F Informa UK, 2006, chapter 5.

Suitable bactericides are bronopol and isothiazolinone derivatives such as alkylisothiazolinones and benzisothiazolinones. Suitable antifreeze agents are ethylene glycol, propylene glycol, urea and glycerol. Suitable antifoam agents are silicones, long-chain alcohols, and salts of fatty acids. Suitable colorants (e.g. in red, blue, or green) are pigments which are sparingly soluble in water, and water-soluble dyes. Examples are inorganic colorants (e.g. iron oxide, titanium oxide, iron hexacyanoferrate) and organic colorants (e.g. alizarin, azo and phthalocyanine colorants).

The concentrate preferably comprises at least one anionic surfactant. The concentrate usually comprises not less than 0.5% by weight of anionic surfactants, preferably not less than 2% by weight and in particular not less than 3% by weight. The composition can comprise not more than 30% by weight of anionic surfactants, preferably not more than 15% by weight and in particular not more than 10% by weight.

The concentrate preferably comprises at least one nonionic surfactant (such as alkoxylates). The concentrate usually comprises not less than 1% by weight of nonionic surfactants, preferably not less than 5% by weight and in particular not less than 10% by weight. The composition can comprise not more than 65% by weight of nonionic surfactants, preferably not more than 45% by weight and in particular not more than 35% by weight.

In a preferred form, the concentrate preferably comprises at least one alkoxylate, in particular an alkoxylated C₆-C₂₂-alcohol. The concentrate usually comprises not less than 2% by weight of alkoxylates (in particular an alkoxylated C₆-C₂₂-alcohol), preferably not less than 7% by weight and in particular not less than 10% by weight.

Preferably, the concentrate comprises a nonionic surfactant (such as alkoxylates) and an anionic surfactant (such as sulfates or sulfonates).

The invention furthermore relates to a process for the preparation of the emulsifiable concentrate according to the invention by mixing the water-insoluble pesticide, the alkyl benzoate, and the amide of the formula (I).

The invention furthermore relates to an emulsion obtainable (preferably obtained) by mixing water, the water-insoluble pesticide, the alkyl benzoate, and the amide of the formula (I). The emulsion normally arises spontaneously upon mixing. In most cases, the emulsion is an oil-in-water emulsion. The mixing ratio of water to concentrate can be in the range of from 1000 to 1 up to 1 to 1, preferably 200 to 1 up to 3 to 1.

The invention furthermore relates to a method for controlling phytopathogenic fungi and/or undesired vegetation and/or undesired attack by insects or mites and/or for regulating the growth of plants, where the concentrate according to the invention or the emulsion according to the invention is allowed to act on the respective pests, their environment or on the crop plants to be protected from the respective pests, on the soil and/or on undesired plants and/or on the crop plants and/or their environment. In general, the therapeutic treatment of humans and animals is excluded from the method for controlling phytopathogenic fungi and/or undesired vegetation and/or undesired attack by insects or mites and/or for regulating the growth of plants.

When employed in crop protection, the application rates of the pesticides amount to from 0.001 to 2 kg per ha, preferably from 0.005 to 2 kg per ha, especially preferably from 0.05 to 0.9 kg per ha and in particular from 0.1 to 0.75 kg per ha, depending on the nature of the desired effect. In treatment of plant propagation materials such as seeds, e.g. by dusting, coating or drenching seed, amounts of active substance of from 0.1 to 1000 g, preferably from 1 to 1000 g, more preferably from 1 to 100 g and most preferably from 5 to 100 g, per 100 kg of plant propagation material (preferably seed) are generally required. When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizers or micronutrients and further pesticides (for example herbicides, insecticides, fungicides, growth regulators, safeners) may be added to the emulsion in the form of a premix or optionally only shortly before use (tank mix). These agents can be admixed to the compositions according to the invention at a weight ratio of from 1:100 to 100:1, preferably from 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

Advantages of the present invention are, inter alia, that the concentrate is highly stable to low temperatures (e.g. even below 0° C.); that the pesticide does not precipitate, cream or crystallize in the concentrate at low temperatures (e.g. even below 0° C.); that the pesticide does not precipitate, cream or crystallize in the emulsion obtained from the concentrate, e.g. at low temperatures (e.g. even below 0° C.); that high pesticide concentrations in the concentrate can be employed; that an emulsion forms spontaneously upon dilution of the concentrate with water; that the concentrate is capable of being stored over prolonged periods; that the concentrate does not require the presence of water (e.g. because it might freeze below 0° C. or would favor bacterial growth during storage); that the concentrate forms a stable emulsion upon dilution with water; that adjuvants (such as alcohol alkoxylates) can be included in the concentrate formulations; that the pesticide does in the emulsion obtained from the concentrate does not clog any spraying filters or nozzles, e.g. at low temperatures, or when diluted with hard water.

The examples which follow illustrate the invention without imposing any limitation.

### EXAMPLES

Lactate: 2-ethylhexyl-(S)-lactate
Amide 1: N,N-dimethyldodecanamide
Amide 2: N,N-dimethyldecanamide
Butyl benzoate: n-butyl benzoate
Copolymer 1: Nonionic polymer obtainable by radical polymerization of 38 wt % vinylpyrrolidone, 20 wt % tert-butyl acrylate, 29 wt % methyl methacrylate, 3 wt % methacrylic acid and 10 wt % C_{16/18} alkyl terminated polyethylene glycol methacrylate (containing 25 ethylene glycol units).
Copolymer 2: Nonionic polymer obtainable by radical polymerization of 38 wt % vinylpyrrolidone, 20 wt % tert-butyl acrylamide, 29 wt % methyl methacrylate, 3 wt % methacrylic acid and 10 wt % C_{16/18} alkyl terminated polyethylene glycol methacrylate (containing 25 ethylene glycol units).
NS1: nonionic surfactant, liquid alkoxylated fatty alcohol, surface tension (1 g/l, 23° C.) 28-30 mN/m; Brookfield viscosity (23° C.) 70-80 mPas.
NS2: nonionic surfactant, liquid ethoxylated and propoxylated fatty alcohol; water-insoluble; freezing point about −12 to −5° C.; Brookfield viscosity (23° C.) 110-125 mPas.
NS3: nonionic surfactant, liquid ethoxylated polyalkylarylphenol, HLB 12-13.
NS4: nonionic surfactant, ethoxylated castor oil.
NS5: nonionic surfactant, liquid alkoxylated fatty alcohol, surface tension (1 g/l, 23° C.) 31-33 mN/m; Brookfield viscosity (23° C.) 130-140 mPas.
Additive 1: water-soluble, polar organic liquid.
Hydrocarbon 1: Technical mixture of aromatic hydrocarbons, boiling range 240-300° C.

### Examples 1

### Preparation of Emulsifiable Concentrates (EC) and Application Test

The emulsifiable concentrates of fluxapyroxad (each 125 g/l) were prepared by mixing the components and making up to 1.0 l with Amide 1. The compositions are summarized in Table 1.

TABLE 1
Composition (all data in g/l)

| | A | Comp-A1^{a)} | Comp-A2^{a)} | Comp-A3^{a)} |
|---|---|---|---|---|
| NS1 | 25 | 25 | 25 | 25 |
| NS2 | 150 | 150 | 150 | 150 |
| Copolymer 1 | 75 | 75 | 75 | 75 |
| Lactate | — | — | 140 | — |
| Butyl benzoate | 140 | — | — | ad 1 l |
| Amide 1 | ad 1 l | ad 1 l | ad 1 l | — |
| Application test | Free | Clogged | Clogged | n/a |

^{a)}comparative, not according to the invention.

Application test: The test below was used to investigate whether the emulsifiable concentrates, following dilution to a sprayable concentration, can be used in standard sprayers without clogging the filters of the spraying machine or the spraying nozzles.

The test machine was a hydraulic sprayer with a 195 l tank, a four-piston membrane pump (at 3 bar pressure) and a spraying lance with 6 standard nozzles (type: LU 90-03). Nozzle filters used were four mesh filters (25, 50, 60, and 80 mesh), a 60-mesh mesh filter with integrated seal, and a 25-mesh slot filter. The suction filter and the pressure filter were each 50-mesh mesh filters.

The tank was first filled with 75 l of water and thereafter the 3 l of an emulsifiable concentrate of the example. The mixture was mixed with a piston pump (stirring intensity: about 45 l/min) and subsequently the tank was filled up with a further 75 l of water. After pumped circulation for 15 minutes (stirring intensity: about 45 l/min) of the product mixture, the spray solution was sprayed out of the tank through the nozzles. During the test, the temperature of the spray mixture in the tank was kept constant at between 5 and 10° C. in order to simulate cold well water. The delivery test was repeated 3 times without cleaning the instruments between each application. At the end of this procedure, the filters ahead of and downstream of the pump (suction filter and pressure filter) and the filters in the nozzles (nozzle filters) were examined for residues. Table 1 summarizes the results. In the table, “clogged” means that at least one of the filters (suction, pressure or nozzle filters) showed significant fouling, causing a reduction in flow or clogging. “Free” in the table means that no significant fouling was found.

The data showed that the EC formulation “A” following dilution to a sprayable concentration can be used in standard sprayers without clogging the filters of the spraying machine or the spraying nozzles.

For comparison, when butyl benzoate was omitted (“Comp-A1”) or when butyl benzoate was substituted by 2-ethylhexyl-(S)-lactate (“Comp-A2”) this application test could not be passed.

In another comparative test, the Amide 1 was omitted and only butyl benzoate was used (“Comp-A3”). As a result undissolved pesticide particles remained and no homogenous solution was formed. Thus, the above application test could not be made (“n/a” in Table 1).

### Examples 2

### Preparation of Emulsifiable Concentrates (EC) and Biological Testing

The emulsifiable concentrates of fluxapyroxad (66.7 g/l), difenoconazol (100 g/l) and pyraclostrobin (133 g/l) were prepared by mixing the components and making up to 1.0 l with butyl benzoate or Hydrocarbon 1. The compositions are summarized in Table 1.

TABLE 2
Composition (all data in g/l)

| | B | Comp-B1^{a)} | Comp-B2^{a)} |
|---|---|---|---|
| NS1 | 200 | 200 | 200 |
| NS3 | 40 | 40 | 40 |
| NS4 | 70 | 70 | 70 |
| Additive 1 | 50 | 50 | 50 |
| Amide 2 | 200 | 200 | |
| Butyl benzoate | ad 1 l | — | ad 1 l |
| Hydrocarbon 1 | — | ad 1 l | |

^{a)}comparative, not according to the invention.

The pesticidal activity was tested in a greenhouse on soy plants which were infected with asian soybean rust (Phakopsora pachyrhizi). Four days after infection point, plants were treated with formulations, and 10 days after the infection, the percentage of disease was evaluated with the given dose rate. The results are summarized in Table 2.

The data in Table 2 showed that the EC according to the invention (Example B) has an increased pesticidal activity compared to comparative Example “Comp-B1”, wherein butyl benzoate was substituted by Hydrocarbon 1.

In another comparative test, the Amide 1 was omitted and only butyl benzoate was used (“Comp-B2”). As a result undissolved pesticide particles remained and no homogenous solution was formed.

TABLE 2
Percentage of disease (%)

| Dose rate | | |
|---|---|---|
| [g ai per ha] | B | Comp-B1^{a)} |
| 225 | 2 | 4 |
| 45 | 17 | 44 |
| 9 | 64 | 83 |

^{a)}comparative, not according to the invention.

### Examples 3

### Preparation of Emulsifiable Concentrates (EC) and Application Test

The emulsifiable concentrates of fluxapyroxad (each 125 g/l) were prepared by mixing the components and making up to 1.0 l with Amide 1. The compositions are summarized in Table 3 and passed the application test as described in Example 1.

TABLE 3
Composition (all data in g/l)

| | C | D |
|---|---|---|
| NS1 | — | 25 |
| NS2 | 100 | 100 |
| NS4 | 50 | — |
| Copolymer 1 | 75 | 75 |
| Butyl benzoate | 165 | 190 |
| Amide 1 | ad 1 l | ad 1 l |
| Application test | Free | Free |

### Examples 4

### Preparation of Emulsifiable Concentrates (EC) and Application Test

The emulsifiable concentrates were prepared by mixing the components as described in Table 4. All compositions passed the application test as described in Example 1.

TABLE 4
Composition (all data in wt %)

| | E | F | G |
|---|---|---|---|
| Fluxapyroxad | 12 | 12 | 12 |
| NS1 | 2.5 | 2.5 | 2.5 |
| NS5 | 15 | 10 | 10 |
| Copolymer 1 | 7.5 | 7.5 | 7.5 |
| Butyl benzoate | 14 | 14 | 19 |
| Amide 1 | 49 | 54 | 49 |
| Application test | Free | Free | Free |

### Examples 5

### Preparation of Emulsifiable Concentrates (EC) and Application Test

The emulsifiable concentrates were prepared by mixing the components as described in Table 5. All compositions passed the application test as described in Example 1.

TABLE 5
Composition (all data in wt %)

| | H | I | K |
|---|---|---|---|
| Fluxapyroxad | 12 | 12 | 12 |
| NS1 | 2.5 | 2.5 | 2.5 |
| NS5 | 15 | 10 | 10 |
| Copolymer 2 | 7.5 | 7.5 | 7.5 |
| Butyl benzoate | 14 | 14 | 19 |
| Amide 1 | 49 | 54 | 49 |
| Application test | Free | Free | Free |

1-15. (canceled)

16. An emulsifiable concentrate comprising a water-insoluble pesticide,
a) an alkyl benzoate where the phenyl group is optionally substituted with at least one alkyl group, and
b) an amide of the formula (I)
R¹—C(O)N(R²)₂ (I)
where R¹ is C₅-C₁₉-alkyl and R² is C₁-C₄-alkyl.

17. The concentrate according to claim 16, comprising at least 10% by weight of the amide of the formula (I).

18. The concentrate according to claim 16, comprising at least 5% by weight of the alkyl benzoate.

19. The concentrate according to claim 16, wherein the alkyl benzoate is C₁₋₁₂ alkyl benzoate, where the phenyl group is optionally substituted with one or two C₁₋₃ alkyl groups.

20. The concentrate according to claim 16, wherein the alkyl benzoate is C₁₋₆ alkyl benzoate, where the phenyl group is optionally substituted with one or two methyl groups.

21. The concentrate according to claim 16, wherein the alkyl benzoate is n-butyl benzoate.

22. The concentrate according to claim 16, wherein R¹ is C₇-C₁₁-alkyl and R² is methyl.

23. The concentrate according to claim 16, comprising from 5 to 50% by weight of the alkyl benzoate, and 5 to 65% by weight of the amide of the formula (I), wherein the amounts of these components adds up to a sum of 40 to 95% by weight.

24. The concentrate according to claim 16, wherein the weight ratio of the alkyl benzoate to the amide of the formula (I) is in the range from 1:20 to 10:1.

25. The concentrate according to claim 16, comprising at least 5% by weight of a nonionic surfactant.

26. The concentrate according to claim 16, wherein the concentrate is present as a homogeneous solution.

27. The concentrate according to claim 16, wherein the concentrate is largely free from water.

28. A process for the preparation of the concentrate according to claim 16 by mixing the water-insoluble pesticide, the alkyl benzoate and the amide of the formula (I).

29. An emulsion obtainable by mixing water, a water-insoluble pesticide, an alkyl benzoate as defined in claim 16.

30. A method for controlling phytopathogenic fungi and/or undesired vegetation and/or undesired attack by insects or mites and/or for regulating the growth of plants, where the concentrate according to claim 16 is allowed to act on the respective pests, their environment or on the crop plants to be protected from the respective pests, on the soil and/or on undesired plants and/or on the crop plants and/or their environment.

31. The method of claim 30, wherein the concentrate comprises at least 10% by weight of the amide of the formula (I).

32. The method of claim 30, wherein the concentrate comprises at least 5% by weight of the alkyl benzoate.

33. The method of claim 30, wherein the alkyl benzoate in the concentrate is C₁₋₁₂ alkyl benzoate, where the phenyl group is optionally substituted with one or two C₁₋₃ alkyl groups.

34. The method of claim 30, wherein the alkyl benzoate in the concentrate is C₁₋₆ alkyl benzoate, where the phenyl group is optionally substituted with one or two methyl groups.

35. The method of claim 30, wherein the alkyl benzoate in the concentrate is n-butyl benzoate.

36. The method of claim 30, wherein R¹ is C₇-C₁₁-alkyl and R² is methyl.

37. The method of claim 30, wherein the concentrate comprises from 5 to 50% by weight of the alkyl benzoate, and 5 to 65% by weight of the amide of the formula (I), wherein the amounts of these components adds up to a sum of 40 to 95% by weight.

38. The method of claim 30, wherein the weight ratio of the alkyl benzoate to the amide of the formula (I) in the concentrate is in the range from 1:20 to 10:1.

39. The method of claim 30, wherein the concentrate comprises at least 5% by weight of a nonionic surfactant.

40. The method of claim 30, wherein the concentrate is present as a homogeneous solution.
